(19) United States
(12) Patent Application Publication
(10) Pub. No.: US 2016/0304142 A1
(43) Pub. Date: Oct. 20, 2016

(54) ADJUSTABLE PIVOT MODULE FOR ENDLESS TRACK SYSTEM

(71) Applicant: Soucy International Inc., Drummondville (CA)

(72) Inventors: Keven BOUTIN, Drummondville (CA); Gabriel AUGUSTIN, St-Damase (CA); Nicolas DUBUC, Mercier (CA); Steve FRECHETTE, St-Liboire (CA)

(21) Appl. No.: 15/131,884

(22) Filed: Apr. 18, 2016

Related U.S. Application Data
(60) Provisional application No. 62/149,049, filed on Apr. 17, 2015.

(51) Int. Cl. B62D 55/084; B62D 55/32

(52) U.S. Cl. CPC B62D 55/084; B62D 55/32

(57) ABSTRACT

An adjustable pivot module for an endless track which aims at optimizing the adjustment of a track assembly, regardless of the geometry of the track assembly. The adjustable pivot module may be configured to be mounted in different positions to account for geometric and performance constraints. The pivot pin module comprises a housing adapted to pivotally receive a pivot pin from a vehicle or equipment. The module is adapted to provide different offset values with regard to a horizontal axis and/or a vertical axis.

### CROSS-REFERENCE TO RELATED APPLICATIONS

The present application claims priority of the U.S. provisional application No. 62/149,049 filed Apr. 17, 2015 at the USPTO, the content of which is incorporated herein by reference.

### FIELD OF THE INVENTION

The present invention relates to the field of endless track system for vehicles and machinery typically used in areas such as agriculture, construction, forestry, mining and powersports. More particularly, the present invention relates to the field of adjustable pivoting device, means and methods for endless track system or track assemblies.

### BACKGROUND OF THE INVENTION

Agricultural vehicles (harvesters, combines, tractors, trailed implements such as planters, grain carts, etc.) become heavier year after year. Most of such vehicles use wheels—i.e. tires—to move on the ground. In such configuration, each wheel applies a relatively high pressure on the ground. One way to reduce or distribute the pressure applied on the ground is to equip such vehicles with endless track undercarriages or systems, either as a factory-installed option or as an aftermarket (add-on) kit.

One of the challenges found in the process of fitting tracks to a wide variety of models and machine configurations is the limited space available around axles. In such plethora of designs of different models and brands of vehicles, many features, such as but not limited to, fuel tanks, hitches, harvest headers, toolboxes, planting units, etc. may be located in an area preventing or limiting the installation of a common undercarriage geometry.

Hence, in view of the foregoing, there is a need for an improved system or device to facilitate the fitting or installation of different configurations of endless track assemblies to more types and models of vehicles which will at least mitigate some of the shortcomings of systems using collision avoidance devices.

### SUMMARY OF THE INVENTION

Some of the shortcomings of prior art installation and fitting system for endless track systems are at least mitigated by an adjustable pivot pin module to adapt a single endless track system or undercarriage to numerous configurations. Such system aims at least at mitigating the shortcomings of the prior art in order for each configuration to be optimized to provide better possible performance and handling while coping with particular vehicle types and models or space constraints.

The invention present a rubber track undercarriage featuring main pivot pin that can be installed in a variety of positions to better suit performance requirements and spatial constraints. It also comprises two pairs of idler wheels (front and rear), of which one can also be used with a tensioning device to tension the track; a main undercarriage frame, which can consist in a rigid structure or in a combination of structures connected by pivot pins to act as tandems; one or more sets of mid-rollers; in some configurations, a suspension system; in some configurations, a drive sprocket; in some configurations, a gearbox or final drive to achieve the desired ground speed.

One aspect of the present invention is that an undercarriage or track geometry may be configured to be mounted in different positions to account for geometric and performance constraints. The use of an endless track system typically allow a generally even load distribution between the front portion of the track in contact with the ground and the rear portion also in contact with the ground. In an event where a higher load is distribute on the front portion of the track, the front portion of the track shall have a tendency to dive or dig in the ground. To the opposite, an uneven load being distributed toward the rear portion of the track shall tend to pivot the track system in a way to raise the front portion of the track. Understandably, uneven load between the front and rear sections of the track is not desirable.

However, some features present on a vehicle or non-driven equipment may prevent the track system to have an uneven load distribution or to force adequate horizontal and/or vertical position of the track system. In such configurations, a different track system would be required for each type or model of vehicle/equipment, or even for each different configurations, options or features which exist, in order to generally provide great efficiency and performances. The multi-position/adjustable pin module allows to use standard undercarriage geometry and to offset it forward, rearward, upward or downward. As such, the pivot may be mounted to vehicle to adapt to nearly all vehicle constraints and to minimize uneven distribution of load on the track.

As an example, a track system must be mounted to first and second different models of vehicle. The first model provides a limited available space for fitting tracks while the second model provides more space. Using a fixed pivot design configuration, the two most probable options would be the followings:
1. Design one undercarriage on which the pivot pin is located in a non-ideal position (for example with a significant forward offset) to clear all spatial constraints of the first model. In this situation, when mounted on the second model, the track system shall have a tendency to dive, even if space would allow for a better balanced geometry.
2. Design two undercarriages, one for each model, taking accounts of the particular spatial constraints of each model. In this situation, undercarriage geometry would be optimized but would require the design of two final and tested assemblies.

The invention is directed to a track system for a vehicle, the track system comprising a support frame pivotally mounted to an attachment point, such as a protruding portion, of the vehicle; a plurality of wheels pivotally mounted on the support frame; and an endless track disposed around the plurality of wheels, the endless track defining an overall perimeter of the track system. The track system is movable with regards to the attachment point along the width and/or the length of the vehicle

The track system also comprises a pivot module, the pivot module being adapted to be mounted to the support frame, the pivot module comprising a portion adapted to pivotally receive the attachment point. The support frame comprises a portion adapted to receive the pivot module in different positions. In a preferred embodiment, the pivot module is mounted on the support frame using fasteners. Accordingly, both the pivot module and the receiving surface of the support frame comprise corresponding fasteners receiving locations, such as holes.

The pivot module is movable following a 180 degrees rotation about an axis substantially perpendicular to a plane defined by the receiving surface and/or following a translation with regards to said plane.

A longitudinal axis of the attachment point or protruding portion is substantially parallel to the width of the vehicle. In a preferred embodiment, the pivotally receiving portion is a hollow portion, preferably cylindrical, adapted to receive the protruding portion.

The invention is also directed to a vehicle comprising a track system as described herein above.

The invention is further directed to a method for adjusting a position of a track system with regards to the length and/or the width of a vehicle having a pivotal attachment point adapted to receive said track system, the method comprising the step of moving the track system longitudinally and/or transversally in relation to the pivotal attachment point.

The method for adjusting the position of the track system as described above may further comprise the step of moving a pivot module with regards to a support frame of the track system, the pivot module being adapted to be mounted on a receiving surface of the support frame, the pivot module comprising a portion adapted to engage the pivotal attachment point of the vehicle, wherein the movement of the pivot module changes a position of the portion with regards to the support frame.

The method for adjusting the position of the track system as described above may further comprise the steps of releasing the pivot module such that the pivot module is able to move with regards to the receiving surface; moving and/or rotating the pivot module with regards to the receiving surface; attaching the pivot module to the receiving surface; removing fasteners from holes of the receiving surface and holes of the pivot module; aligning holes of the pivot module with different holes of the receiving surface; and fastening the pivot module to the receiving surface.

### BRIEF DESCRIPTION OF THE DRAWINGS

The above and other aspects, features and advantages of the invention will become more readily apparent from the following description, reference being made to the accompanying drawings in which:

FIG. 1 is a side view of a generic track undercarriage comprising a pivot pin module in accordance with the principles of the present invention, the pivot pin module being mounted to the carriage in a rearward offset position.

FIG. 2 is a perspective exploded view of a pivot pin module un-mounted to a generic track undercarriage in accordance with the principles of the present invention.

FIG. 3 is a side view of a same generic track undercarriage comprising a pivot pin module in accordance with the principles of the present invention, the pivot pin module being mounted to the undercarriage. In this embodiment, the pivot pin module is mounted toward the front end of the undercarriage in a forward offset position.

FIG. 4 is a perspective view of a second embodiment of the invention in accordance with the principles of the present invention.

FIGS. 5A-C are top views of different configurations of the embodiment of FIG. 4.

### DETAILED DESCRIPTION OF THE PREFERRED EMBODIMENT

A novel adjustable pivot pin module will be described hereinafter. Although the invention is described in terms of specific illustrative embodiments, it is to be understood that the embodiments described herein are by way of example only and that the scope of the invention is not intended to be limited thereby.

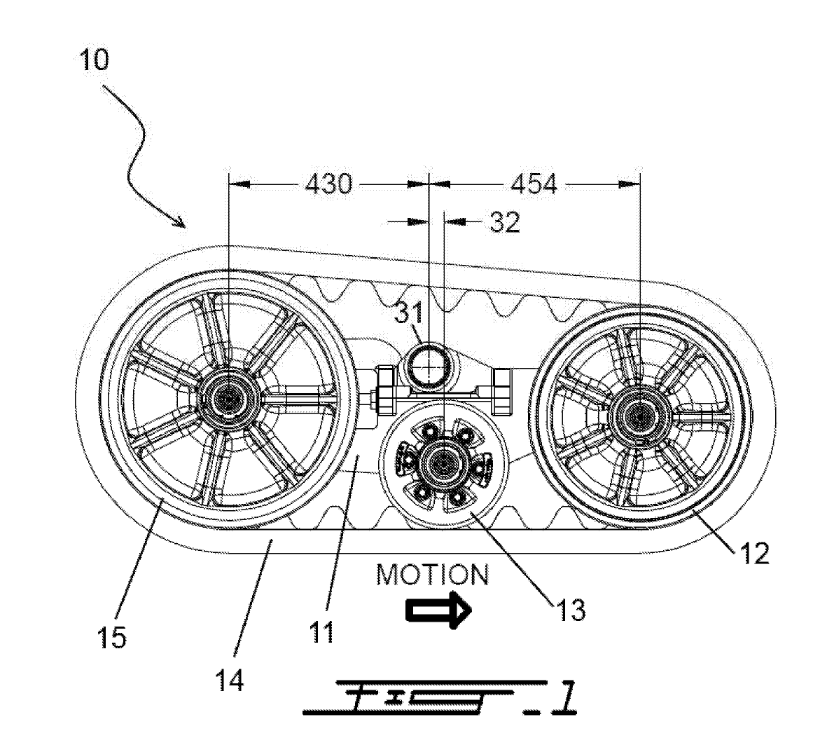

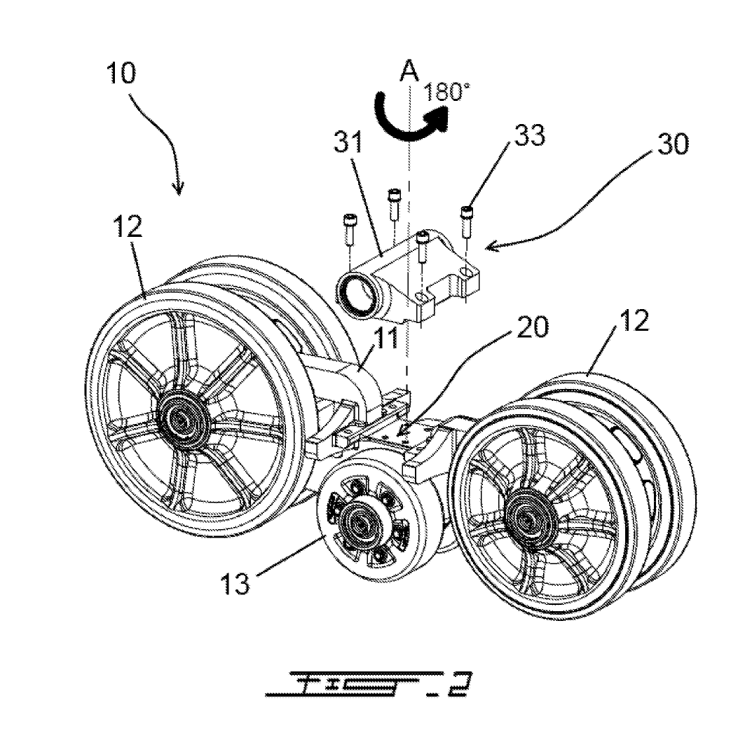

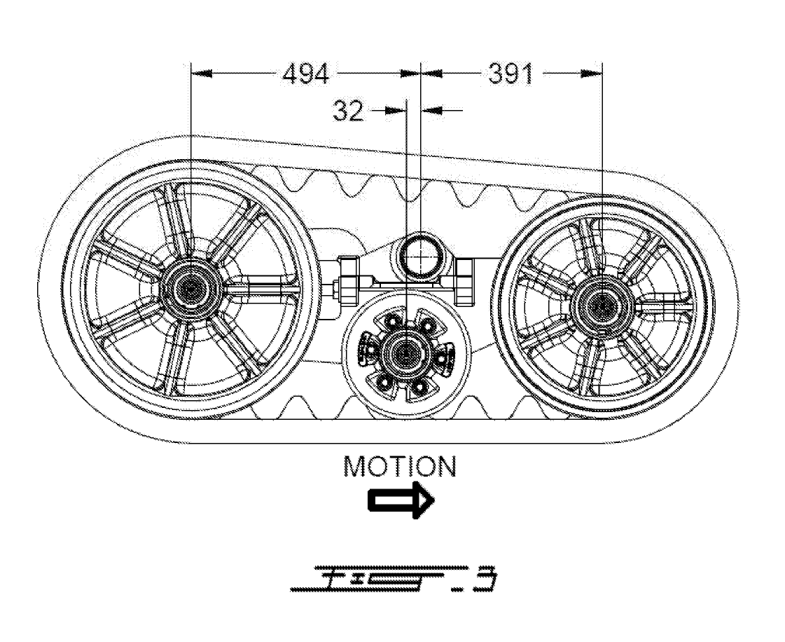

Now referring to FIGS. 1 to 3, a track system having a pivot mechanism or device 30 is shown. The track system 10 generally comprises a drive wheel (e.g. a sprocket wheel) 15 configured to be mounted to the vehicle, typically to the wheel hub where a wheel was previously mounted, a support frame (or support frame assembly) 11 mounted to the drive wheel 15 or mountable to the vehicle, at least one idler wheel 12 pivotally mounted to the support frame and an endless traction band 14 disposed about the wheels and configured to be driven or not by the drive wheel 15.

The track system may further comprise a road wheel 13 pivotally mounted to the support frame along its length, typically between the drive wheel 15 and the idler wheel 12. In other embodiments, the drive wheel 15 may be replaced by an idler wheel for a non-driven configuration. Understandably, the track system 10 may mounted on driven vehicle, as found on tractors, combines, sprayers and other self-propelled equipment or may be mounted on non-driven implements and equipments.

Still referring to FIGS. 1 to 3, an embodiment of a pivot mechanism module 30 is illustrated. The pivot mechanism module 30 is pivotally mounted to an endless track system 10 and allows the track system, once mounted, to pivot with regard to an axis substantially parallel to the axles of the vehicle or equipment.

In a preferred embodiment, the pivot mechanism is a pivot pin. Understandably, any other method or mechanism allowing the pivoting of the frame 11 of the track system 10 with regard to an axis substantially parallel to the axles of the vehicle or equipment could be used.

The pivot pin module 30 comprises a pivot pin housing 31 adapted to pivotally receive a pivot pin from the vehicle. The axis A shows the vertical centerline of the pivot module 30. As better shown in FIG. 1, an offset 32 is present between the generally central portion of the pivot pin housing 31 and the vertical centerline A.

It should be understood that, generally, the vertical axis A is substantially perpendicular to frame 11 of the track assembly 10 or to a surface of a receiving member 20. As such, in embodiments where the frame 11 and/or the surface of a receiving member 20 is configured to have an angle with respect to the frame 11 or to the ground, the vertical center line would have a similar angle as the vertical center line is substantially perpendicular with respect to the frame 11 or the receiving member 20.

The pivot module 30 may be removably or fixedly fastened or mounted to the main undercarriage frame using any method which ensures that the module remains solidly attached to the endless track system. In a preferred embodiment, the module 30 is mounted to the undercarriage 10 using bolts 33 and fasteners (not shown), allowing the easy removal of the module 30. As such, the pivot pin module 30 may be removed from the frame 11, typically by loosening and removing fasteners. Once removed, the pivot pin module 30 may be rotated 180 degrees around the vertical axis A to reverse the offset from front to rear, or vice versa.

In a preferred embodiment, a receiving member 20 is adapted to receive the pivot module 30. The receiving member 20 may be mounted or attached to the frame 11 of the track assembly 10 or may be unitary with the frame 11. In an embodiment using bolt 33, the receiving member 20 comprises apertures, such as threaded aperture, adapted to receive the bolt 33. In a preferred embodiment, the receiving member 20 comprises a surface, typically substantially flat, for receiving a compatible surface of the module 30. The surface is typically substantially parallel to the ground or longitudinally parallel to the track assembly 10. In other embodiments, the receiving member could provide inclined surface, typically ranging from about 0 degree to 15 degrees, in order to provide a rotation axis of the module having an angle with respect to the ground or non-flat surface being compatible with one or more surfaces of the housing of the module 30.

Understandably, in other embodiments, the pivot module 30 may be removably attached directly to the frame 11 using any attachment mean without using of a receiving member 20.

In another embodiment, the pivot module 30 comprises the housing 31. In such an embodiment, the generally central portion of the housing 31 is offset 32 with respect to the horizontal centerline of the module 30. The module 30 may be removed to allow the pivoting of the module with regard to a longitudinal axis substantially parallel to the support frame. Typically, the module 30 is limited to 180 degrees of rotation. Once removed, the vertical offset of the module 30 may be changed from a low position to a high position, or vice versa.

In yet another embodiment, the pivot pin module comprises the housing 31. In such an embodiment, the generally central portion of the housing 31 is offset 32 with respect to the substantially vertical centerline of the module 30 (i.e. longitudinally) and is offset with respect to the substantially horizontal centerline of the module 30 (i.e. horizontally). The module 30 may be removed to allow the pivoting of the module with respect to a longitudinal axis parallel to the support frame and/or with respect to a vertical axis A. Typically, the module is limited to 180 degrees of vertical rotation and 180 degrees of horizontal rotation. Once removed, the vertical offset of the module 30 may be changed from a low position to a high position, or vice versa and/or from a front offset to a rear offset, or vice versa.

In the present embodiment, by pivoting or rotating the module 30 with respect to either or both the substantially vertical and substantially horizontal axis, one may change the horizontal and vertical offsets to one of the following four positions: forward low, forward high, rearward low, rearward high.

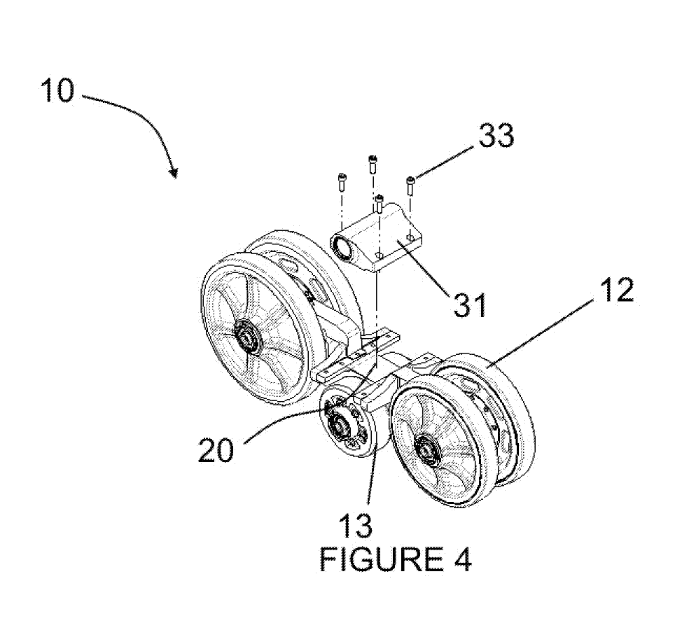

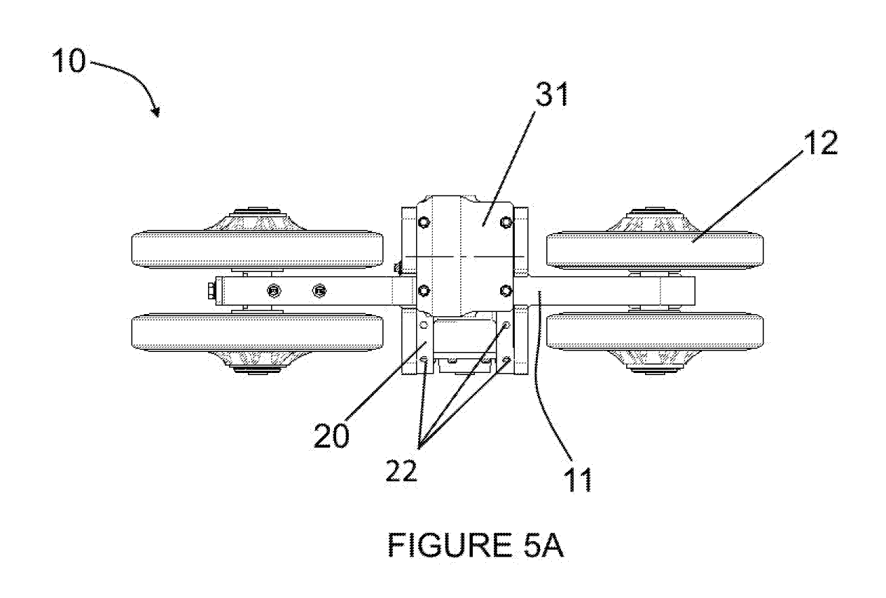

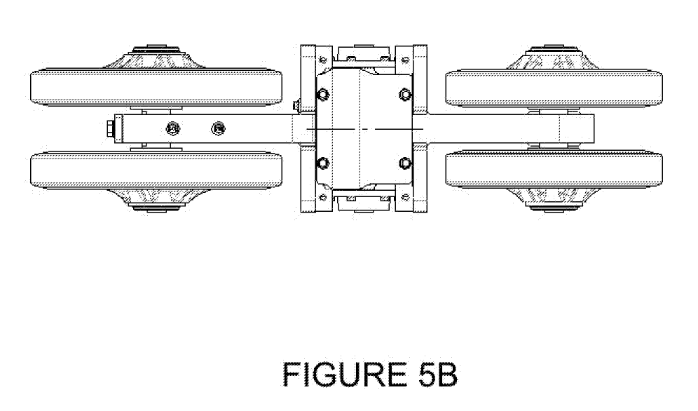

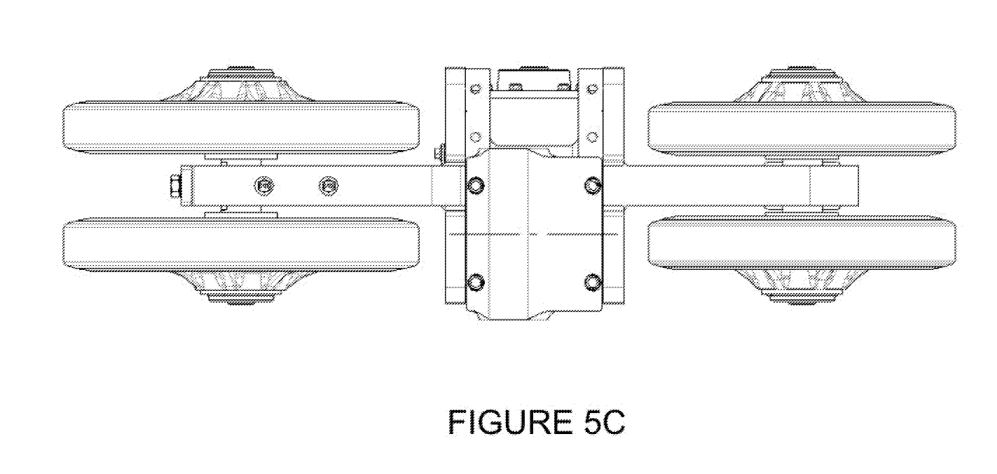

Now referring to FIGS. 4 and 5A, in yet other embodiments, the receiving member 20 or the frame 11 may be configured to provide further attachment points, such as apertures 22, to allow many more positions. As such, the receiving member 20 may also comprise a slide or a mechanism allowing the module 30 to be moved about the horizontal central line and to be attached to provide a higher granularity in the positions of the module 30 in relation to the frame 11.

Now referring to FIGS. 5A to 5C, in this embodiment, the pivot module 30 is able to move in a direction substantially parallel to the axis of rotation of the wheels 12. Accordingly, it is possible to reduce or increase the distance between two track systems disposed on each side of a tracked vehicle. Such embodiment offers a greater granularity in the possible positioning of the track system as one may simultaneously change the position of the track system with regards to both the width and/or the length of the tracked vehicle.

Still referring to FIGS. 4 and 5A to 5C, to modify the position of a track system 10 along the width of the vehicle, the pivot module 31 is moved laterally. Accordingly, a plurality of holes defining bolt patterns 22 are provided on the receiving surface 20 of the support frame 11.

Also, even if not illustrated on the provided figures, it would be possible to provide a plurality of holes or bolt patterns 22 on the receiving surface 20 to change the position of the pivot module 31 with regards to the length of the vehicle without having to rotate said module 31.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A track system for a vehicle, the track system comprising:
a support frame pivotally mounted to an attachment point of the vehicle;
a plurality of wheels pivotally mounted on the support frame; and
an endless track disposed around the plurality of wheels, the endless track defining an overall perimeter of the track system,
wherein the track system is movable with regards to the attachment point along the width and/or the length of the vehicle.

2) The track system of claim 1, the track system comprising a pivot module, the pivot module being adapted to be mounted to the support frame, the pivot module comprising a portion adapted to pivotally receive the attachment point.

3) The track system of claim 2, the support frame comprising a receiving surface adapted to receive the pivot module in different positions.

4) The track system of claim 3, wherein the pivot module is movable following a 180 degrees rotation about an axis substantially perpendicular to a plane defined by the receiving surface and/or following a translation with regards to said plane.

5) The track system of claim 2, wherein the attachment point is a protruding portion, a longitudinal axis of the protruding portion being substantially parallel to the width of the vehicle, and wherein the pivotally receiving portion is a hollow portion adapted to receive the protruding portion.

6) The track system of claim 5, wherein the hollow portion and the protruding portion have complementary cylindrical shapes.

7) The track system of claim 3, wherein the pivot module is mounted to the receiving surface of the support frame using fasteners.

8) The track system of claim 7, wherein the pivot module and the receiving surface comprise corresponding fastener receiving locations for attaching the pivot module to the receiving surface.

9) The track system of claim 8, wherein the receiving surface comprises a plurality of fastener receiving locations for attaching the pivot module on the receiving surface at a plurality of locations.

10) The track system of claim 1, wherein at least one of the plurality of wheels is a drive wheel.

11) A vehicle comprising a track system as claimed in claim 1.

12) A method for adjusting a position of a track system with regards to the length and/or the width of a vehicle having a pivotal attachment point adapted to receive said track system, the method comprising the step of moving the track system longitudinally and/or transversally in relation to the pivotal attachment point.

13) The method for adjusting the position of the track system of claim 12, the method further comprising the step of moving a pivot module with regards to a support frame of the track system, the pivot module being adapted to be mounted on a receiving surface of the support frame, the pivot module comprising a portion adapted to engage the pivotal attachment point of the vehicle, wherein the movement of the pivot module changes a position of the portion with regards to the support frame.

14) The method for adjusting the position of the track system of claim 13, the method further comprising the steps of:
releasing the pivot module such that the pivot module is able to move with regards to the receiving surface;
moving and/or rotating the pivot module with regards to the receiving surface; and
attaching the pivot module to the receiving surface.

15) The method for adjusting the position of the track system of claim 14, the method further comprising the steps of:
removing fasteners from holes of the receiving surface and holes of the pivot module;
aligning holes of the pivot module with different holes of the receiving surface; and
fastening the pivot module to the receiving surface.
